(19) United States
(12) Patent Application Publication
(10) Pub. No.: US 2005/0154636 A1
(43) Pub. Date: Jul. 14, 2005

(54) Method and system for selling and/ or distributing digital audio files

(76) Inventors: Markus Hildinger, Boston, MA (US); Michael Hildinger, Pforzheim (DE)

Correspondence Address: MARKUS HILDINGER;TIGEM, VIA P. CASTELLINO, 111, NAPLES, 80131, IT

(21) Appl. No.: 10/707,770

(22) Filed: Jan. 11, 2004

(51) Int. Cl. G06F 17/60

(52) U.S. Cl. 705/14

(57) ABSTRACT

The advent of audio compression algorithms in combination with high-speed Internet access has enabled consumers to download digital audio files such as music single tracks from the Internet within seconds to minutes. Whereas legitimate service providers offer music files for download on payment, many consumers download music files illegally at no direct cost by using file sharing or similar services. This leads to a potential loss in revenues for the creators, owners, sellers, and/or distributors of digital audio content. The present invention relates to a method and system for selling and/or distributing digital audio files comprising at least one advertisement message part in addition to at least one music entertainment part. By incorporating an advertisement message part, digital audio files can be sold at a lower price due to additional advertising revenues, which in turn will induce more consumers to legally purchase digital audio files, thus potentially increasing overall revenues for the creators, owners, sellers, and/or distributors of digital audio content.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever. The inventors can be contacted via e-mail (hildinger@gmx.net).

### BACKGROUND OF INVENTION

(1) Field of the Invention

The present invention relates to automated electrical business practice or management arrangement in general, and to a method and system for selling and/or distributing digital audio files in particular, wherein said digital audio file comprises at least one advertisement message part and at least one music entertainment part, where the advertisement message part(s) and the music entertainment part(s) are part of the same digital audio file. If a consumer acquires such a digital audio file and initiates a playback of said file, the consumer will automatically initiate the playback of both the advertisement message part(s) and the music entertainment part(s).

The advent of audio compression algorithms such as the MPEG-3 decoder in combination with high-speed Internet access has enabled consumers to download digital audio files such as music single tracks from the Internet within seconds to minutes. Whereas legitimate service providers offer music files for download on payment such as Apple's iTunes, many consumers download music files illegally at no direct cost by using file sharing or similar services. This leads to a potential loss in revenues for the creators, owners, sellers, and/or distributors of digital audio content.

The present invention relates to a method for selling and/or distributing digital audio files comprising an advertisement message part in addition to the music entertainment part. By incorporating an advertisement message part, digital audio files can be sold at a lower price due to additional advertising revenues, which in turn will induce more consumers to legally purchase digital audio files, thus potentially increasing overall revenues for the creators, owners, sellers, and/or distributors of digital audio content.

The advertisement message part and the music entertainment part are both audio data. In its preferred embodiment, the advertisement message part and the music entertainment part are played sequentially, i.e., without temporary overlap and without the advertisement message part interrupting the music entertainment part. In such a setting, the advertisement message part preferentially precedes the music entertainment part, but may also be played back once the music entertainment part has finished.

How to generate digital audio content in general is already in the public domain, and thus, not claimed as part of this invention. Moreover, one of ordinary skill in the art will be able to convert one digital audio format into another digital audio format without undue effort. Additionally, one of ordinary skill in the art will be able to combine, couple, splice or link the advertisement message part(s) with the music entertainment part(s) without undue effort.

(2) Background (Historic Context) of the Invention

For most part of the 20^{th} century, audio data were stored on plastic records, which did not allow for digital playback. Moreover, consumers could not easily “take their music” with them as there were no portable (pocket) players available for vinyl disks. The manufacture of these plastic records was relatively expensive, requiring the capital expense of record presses and creating metallic master molds. Mold costs had to be amortized over large numbers of copies. The cost of mold masters combined with the skills required to create mold masters prevented the consumer from creating his/her own compilations of songs for private use.

This changed with the advent of magnetic tape recording and the Walkman. The cassette tape allowed the consumer for the first time to make copies of songs stored either on vinyl records or another cassette tape and to create his/her own compilations of songs. As a drawback, the copying process was based on analog technology, and thus quality deteriorated with each copying process, i.e., the copy of the copy of the copy generally did not have the same quality as the original. Moreover, with each playback cycle, playback quality deteriorated as well. The degradation in quality from generation to generation of copies was a deterrent as well as the time required to record each copy. The degradation of the sound consisted of loss of high frequencies, a relatively poor signal-to-noise ratio of the recording (“hiss”) and tonal or volume variations due to mechanical transport of the tape across the recording head (“wow” and “flutter”).

A major improvement was the introduction of the Compact Disk (CD) in the late 20^{th} century. The CD for the first time stored audio data in a digital format. CD's use 16-bit, 44 KHz digital technology so that music recorded on a CD has excellent signal-to-noise ratio, flat frequency response that is wider than human hearing, and no constant or varying pitch distortion. Soon, portable CD players came on the market allowing people to take their music with them. Moreover, CD technology allowed the consumer to make high-quality copies of music in digital form that could potentially be copied with no change or degradation of sound quality. The CD was one of the major technological reasons for the music industry to boom and report record revenues in the late 80's and early 90's.

This all should change with the convergence of four major technological breakthroughs:
(1) The development of audio compression algorithms, allowing music files to be digitally stored at a fraction of their original storage space (as measured in Bits or Bytes) without significant loss of music quality.

(2) The increasing Internet penetration of the population, especially with high-speed (or broadband) Internet connections.

(3) The development of peer-to-peer file sharing services.

(4) The decreasing cost per (mega)byte of storage (memory) and increasing capacity of storage devices (>100 gigabytes).

In digital audio, the main challenge lies in quality and compression (1). Uncompressed audio files are so large that they could not be delivered to users over the Internet in a reasonable amount of time, and they would take up large amounts of hard drive storage space. Thus, compression and decompression technology, or “codecs” were developed to reduce the audio file size: A one-hour music CD requires about 600 megabytes of data (16 bits/sample*44100 samples/sec*3600 sec*2 channels). This large amount of data has discouraged distribution of uncompressed CD content over the Internet, and storage of the CD in hard drives and some external storage devices (such as Memory Cards, Memory Sticks, Secure Digital (SD) cards, Multimedia (MMC) cards, Compact Flash cards, Smart Media cards, USB Flash Disks, Microdrives).

In the late 80's, the Fraunhofer Institute in Germany developed the MPEG-3 format for audio data compression. MPEG compression technology, the most prevalent compression technology, reduces the data capacity by a factor of 8 for CD music, making it easier and less expensive to distribute over the Internet and store. As a result of compression technology it has been economically feasible to download music with CD quality over the Internet. Using an MPEG-3 (de)coder, consumers for the first time were able to convert the musical content of CD's into digital audio files that could be stored and played-back on computers or other decoding devices. Given the smaller file size of these MP3 files (and other compressed audio file formats such as ATRAC3 or WMA), an average consumer can store hundreds to thousands of digital songs on his/her computer or similar device. In summary, digital audio files, such as files in the MP3 (MPEG audio layer 3) format, can be used to store music in a compact form, which is then readily played by a computer, decoding device or specialized digital music (MP3) player, which features a sound device and suitable software. That alone would not impose a threat to the music industry, as consumers are entitled to copy a song for personal use, e.g., to make a back-up copy.

However, with the increasing Internet penetration of the population (2), it became feasible to store and download music from a server via the Internet even if one had not acquired a license to the music content. Given the small file size of compressed audio files (e.g., MP3 files), a download could be achieved in seconds or minutes, particularly through the use of high-speed Internet connections. However, if the technological development had stopped there, damage to the music industry might have been limited, as no one would have offered the download of hundreds or thousands of different songs from a centralized server for free and without being sued by the music industry.

The rise of peer-to-peer file sharing services such as the now defunct Napster (3) or Kazaa pierced this hurdle by eliminating the need for a central server that stores all the files to be shared: Now, every person with internet access on this planet could exchange music files with any other person connected to the internet for free. Thus, many consumers refrained from buying CD's at a cost of $20 to $30, but downloaded the songs they were interested in as digital file from the Internet without a loss of music quality. In summary, the ease of access and transfer of digital audio files has increased problems of piracy of recorded music, including unauthorized copying and distribution of such music without the payment of royalties to the owner of the rights to the music.

These technological trends coincide with a shift in music consumer behavior:

(1) The “album” concept is dying. More and more music consumers now listen to a broad range of music and prefer the best songs of many different artists to all songs of a small group of favorite artists. (There are still “hardcore” fans that will buy complete “albums” and would even pay a premium for premium (DVD) content, but the music industry has not yet tapped into this profit pool. Such premium content could be presented in a form of a DVD and include a “making of the album” feature, an interview with the artist or music videos of the songs of the album.)

(2) “Mobile music”. Consumers want to have access to their music at any given time, not only in the confinement of their homes: When traveling (car; bus; plane), when walking or running, when working out, when waiting. It is nearly impossible to carry a portable CD player and 20 to 30 CD's with you all the time, but digital music players such as Apple's iPod fit in the pocket of your trousers.

The technological trends outlined above favor and enable exactly these shifts in consumer behavior. Combined, they resulted in decreased profitability for the music industry that has heavily relied on the album CD concept. The reaction of the music industry to this “threat” was four-fold:

(1) After a first phase of denial, the music industry attempted to shut down file sharing services by legal action initially by directly suing the file sharing service providers, and later, after this first strategy proved unsuccessful, by suing consumers offering files for download. This approach is generally problematic as it endangers the goodwill of consumers, and it is highly unlikely that lawsuits will make an end to file sharing.

(2) In addition, the music industry began protecting some CD's so that they cannot be played on computers or similar devices, and thus, the content cannot be converted into digital audio files. This represents the most questionable approach the industry has taken: Most music consumers prefer to arrange a collection of different songs themselves, e.g., by combining songs from one CD with those of another CD, and then either burn it to a new CD or transfer them to a portable digital audio (file) player. By making this impossible, the music industry will decrease CD sales even further: A consumer who would have paid $25 for a whole CD to transfer one or two songs s/he likes to another CD now has no incentive at all to buy the CD.

Apart from those more reactive approaches, the music industry also more recently has followed some proactive approaches:

(3) The music industry significantly lowered the prices for CD's in some instances by more than 50%. This measure should induce consumers to legally purchase music instead of using illegal download services. Given the lawsuits against some consumers, there is a potential cost associated with illegal downloading, and some (more risk averse) consumers might prefer paying a smaller amount for a CD than a larger amount in case of a lawsuit or settlement.

(4) The most promising approach the music industry has taken is the establishment of legal download services. First business models in that respect have been developed, e.g., some companies have started selling the right to download and use digital audio files such as singles for $0.99 a piece (e.g., Apple's iTunes), other companies offer a monthly subscription at a fixed price and lower cost per downloaded audio file (e.g., Rhapsody). These paid services are especially attractive for music consumers who are interested in only one or two songs of a whole CD, as they now would have to pay only approximately $1 for a song instead of $10 to $25 for a whole CD. Recently, even Wal-Mart announced the launch of its own music download service, and also Microsoft has announced plans; AOL wants to team up with iTunes, HP entered into an alliance with Apple to use iTunes and sell its own version of Apple's iPod, and Yahoo is said to launch its own service after separating ties with OD2. Amazon.com also joined the ranks of online downloading services and Sony will make its Connect music site, which sells 99-cent song downloads, available in late 2004. Price will play an important role in this yet newly music download market: Napster (revived by Roxio) charges $0.99 as well as iTunes and MusicMatch. Only BuyMusic.com offers songs in a range from $0.79 to $1.29. Wal-Mart is expected to charge $0.88 per song, which according to our market research would leave no profit to Wal-Mart (price equals cost), assuming that Wal-Mart will face the same licensing conditions as all the other download services.

Yet, there is still a gap between the $1 per song of the legal services and the free availability on shared file services such as eMule or Kazaa. If the music industry were able to lower the price per download further, more consumers would be induced to use legal services to acquire music especially as there is some cost or negative value associated with illegal downloading in form of money (lawsuits; settlements) or bad conscience. Our invention will allow for that.

Our invention will allow the music industry to further lower the price per download and thus counteracting illegal file sharing services, by selling and/or distributing digital music in combination with a (short) digital audio advertisement message. Thus, the music could be offered at a significantly lower price or even for free depending on the revenues generated by adding an advertisement message part.

(3) Description of Prior Art

The present invention relates to a method and system for selling and/or distributing digital audio files comprising an advertisement message part in addition to the music entertainment part. By incorporating an advertisement message part, digital audio files can be sold at a lower price due to additional advertising revenues, which in turn will induce more consumers to legally purchase digital audio files, thus potentially increasing overall revenues for the creators, owners, sellers, and/or distributors of digital audio content. Similar strategies have proven successful in other industries such as television (local channels that interrupt their shows to air advertisements in order to offer free content to their viewers), but have not yet been applied to the download or (more generally) distribution of digital audio files.

The advertisement message part and the music entertainment part are both (digital) audio data. In its preferred embodiment, the advertisement message part and the music entertainment part are played sequentially, i.e., without temporary overlap and without the advertisement message part interrupting the music entertainment part. In such a setting, the advertisement message part preferentially precedes the music entertainment part, but may also be played back once the music entertainment part has finished.

How to generate digital audio content is already in the public domain and has been described in prior art, and thus, is not claimed as part of this invention. Moreover, one of ordinary skill in the art will be able to convert one digital audio format into another digital audio format without undue effort. Additionally, one of ordinary skill in the art will be able to combine, couple, or link the advertisement message part with the music entertainment part without undue effort. Besides, how to produce an advertisement message per se and how to produce music entertainment per se is also in the public domain, and thus not claimed in the present invention.

U.S. Pat. No. 6,351,736 is also part of prior art. It claims (quote) “a method and a system for playing a first type of data, such as audio stream data, for the user while simultaneously displaying an advertisement in the form of a second type of data, such as video data. The system and method enable advertisements to be displayed while music is being played from an audio file by the computer of the user, thereby providing an alternative revenue source for the owner of the rights to the audio data. Furthermore, since the advertisement is in a data format, preferably video data, which is different from that of the audio music file, the display of such an advertisement does not interfere with the enjoyment of the music or other audio data being played.” . . . ”Although reference is made to audio files as an example of the data to be retrieved, while the advertisements are described only as being in video format, it is understood that the present invention is applicable to any such combination of two different types of data, in which a first type of data is retrieved by the user for playing on the user computer, while the second type of data is used for the display of the advertisements to the user. “The present invention is substantially different from that prior art patent in several aspects:

(1) U.S. Pat. No. 6,351,736 claims “two different types of data”. Our invention has no need to make use of two different types of data, but has the advantage of using only one type of data, audio data, for conveying both: the music entertainment part and the advertisement message part. In that respect, the present invention is a clear advancement and improvement in the art of conducting business. Moreover, this particular feature of our invention is of great advantage for the music industry because it is aligned with the changing consumer behavior outlined above, the shift towards “mobile music”: Consumers want to listen to music at any time, in any place. For that purpose, they use portable digital audio/music players. These players are carried in a pocket, on a belt, or on a chain around the neck. There would not be an opportunity to display a visual advertisement; and even if an advertising text message were displayed on the display of the player, the user usually would not be aware of it. Our invention instead “forces” the consumer to listen to the advertisement message part. And if the advertisement message part were short (e.g., 3 to 5 seconds), it would not make sense for the user to use the “skip” function many digital music players, decoding devices, software programs or computers offer in order to avoid the advertisement message part.

(2) U.S. Pat. No. 6,351,736 claims “simultaneous” display of an advertisement with a first type of data, such as audio stream data (quote: “advertisements to be displayed while music is being played from an audio file”). Our invention preferentially claims sequential reproduction of the advertisement message part and the music entertainment part, where the advertisement message part preferentially precedes, less preferentially follows, and least preferentially interrupts the music entertainment part. The method applied in our invention has the advantage of making it more difficult for the consumer to “escape” or “avoid” the advertisement message. If the consumer could escape the advertisement message, the cost advantage achieved through incorporating the advertisement message part into the digital audio file would vanish, as advertisers would not be willed to pay in such an instance.

(3) Last, U.S. Pat. No. 6,351,736 claims no interference “with the enjoyment of the music or other audio data being played. “(Quote). Our invention instead does interfere with the enjoyment of music as the advertisement message part being audio data—preferentially precedes, less preferentially follows, and least preferentially interrupts the music entertainment part. We consider interference an advantage for the music industry and advertisers (from the business side) as without interference consumers do not take notice of the advertisement message. (Of course, it is understandable that the consumer might not perceive interference as an advantage; s/he however got reimbursed for that kind of interference by paying a lower price, and thus also indirectly benefits from the “interference”.)

### SUMMARY OF INVENTION

(1) Substance or General Idea of the Claimed Invention

The advent of audio compression algorithms such as the MPEG-3 decoder in combination with high-speed Internet access has enabled consumers to download digital audio files such as music single tracks from the Internet within seconds to minutes. Whereas legitimate service providers offer music files for download on payment such as Apple's iTunes, many consumers download music files illegally at no direct cost by using file sharing or similar services. This leads to a potential loss in revenues for the creators, owners, sellers, and/or distributors of digital audio content. If the music industry were able to lower the price per download, more consumers would be induced to use legal services to acquire music especially as there is some cost or negative value associated with illegal downloading in form of money (lawsuits; settlements) or bad conscience.

Our invention offers a remedy to that problem by allowing the music industry to further lower the price per download and thus counteracting illegal file sharing services, by means of selling and/or distributing digital music in combination with a (short) digital audio advertisement message. Thus, the music could be offered at a significantly lower price or even for free depending on the revenues generated by adding an advertisement message part.

In one preferred embodiment, the present invention relates to a method for selling and/or distributing digital audio files comprising an advertisement message part in addition to a music entertainment part. By incorporating at least one advertisement message part, digital audio files can be sold at a lower price due to additional advertising revenues, which in turn will induce more consumers to legally purchase digital audio files, thus potentially increasing overall revenues for the creators, owners, sellers, and/or distributors of digital audio content. The present invention preferentially claims sequential reproduction of the advertisement message part and the music entertainment part, where the advertisement message part(s) preferentially precede(s), less preferentially follow(s), and least preferentially interrupt(s) the music entertainment part(s). In another aspect of the present invention, the advertisement message part is reproduced as an overlay to the music entertainment part, i.e., the advertisement message part and the music entertainment part are played at the same time. In such a setting, the advertisement message part preferentially is very short in terms of time (preferentially less than 5 seconds) and is preferentially placed at a position where there is no human voice reproduced in the music entertainment part. Overlay can be achieved for example by decreasing the volume of the music entertainment part relative to the advertisement message part. In other embodiments, the advertisement message part and the music entertainment part only overlap; in such a setting, one embodiment could entail that the advertisement message part precedes the music entertainment part, but the last part of the advertisement message part overlaps or is overlaid with the beginning of the music entertainment part. Several combinations and arrangements for the advertisement message part(s) and the music entertainment part(s) might come to the mind of the artist and do not limit the scope or spirit of this invention.

For the present invention, a software application could be written in substantially any suitable programming language, which could easily be selected by one of ordinary skill in the art. The programming language chosen should be compatible with the computer by which the software application is executed, and in particular with the operating system of that computer. Examples of suitable programming languages include, but are not limited to, C, C++, Delphi and Java. Furthermore, the functions of the present invention, when described as a series of steps for a method, could be implemented as a series of software instructions for being operated by a data processor, such that the present invention could be implemented as software, firmware or hardware, or a combination thereof.

The digital audio file comprising the advertisement message part(s) and music entertainment part(s) can be reproduced or played (back) on a wide variety of (decoding) devices, ranging from desktop computers, laptops, hand-held devices, Palm Pilot's, Pocket PC's, Tablet PC's, digital cameras, digital video cameras, digital music players, (portable) audio/music players, digital DVD players, video gaming consoles to cellular phones. The device, method and/or system used to reproduce the digital audio file do not limit the scope or spirit of this invention.

Also, the file format of the digital audio file comprising the advertisement message part(s) and music entertainment part(s) does not limit the scope or spirit of this invention. Moreover, the digital audio file comprising the advertisement message part(s) and music entertainment part(s) can be either compressed or uncompressed. File formats used for digital audio data are without limitation MP3, WMA, WAV, MIDI. Music contents can be distributed by a plurality of EMD systems (Electronic Music Distribution systems) and adopt various audio compression schemes: MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, and the like.

The present invention also claims a system for selling and/or distributing digital audio files comprising at least one advertisement message part in addition to the music entertainment part(s). Such a system can be implemented in numerous ways, and the system implementation does not limit the scope of this invention.

For example, in one embodiment, the system comprises a central server that stores the digital audio files of the invention for download with said digital audio files comprising at least one advertisement message part in addition to the music entertainment part(s). The consumer can access said central server via his/her computer or a similar device by using the Internet or any other network. After the server acknowledges the right to download a specific digital audio file, the consumer will be allowed to download said digital audio file.

In another embodiment, the consumer can gain access to digital audio content by local (computer) stations. Such local stations can be located in music stores, grocery stores, bookstores, gas stations or at any other location. Said local stations mediate access to digital audio files according to the present invention by (a) having said digital audio files stored locally (e.g., on a hard drive or other storage device inside said local station) or by (b) having a network connection to a remote server with said server having stored the digital audio files of the present invention, or (c) any other technically feasible means. Either the local station or a remote server will verify if the consumer has the right to acquire or receive delivery of a particular digital audio file, either by verifying payment (cash; credit card; debit card; coupon; prepaid card) or by any other means technically feasible. Upon successful verification, the consumer then can access (receive delivery of) the digital audio file s/he selected (ordered) by any means technically feasible such as without limitation (a) direct or indirect download (from the local station or from a remote server via the Internet, or via e-mail), (b) wireless transmission (via IR (Infrared); Bluetooth (Version 1 or 2); WiFi; 802.11a/b/g; GSM 900/1800/1900, GPRS, E-GPRS, EDGE, HSCSD, CSD, CDMA, UMTS and 3G networks; etc.) to his/her computing device including cellular phone, (c) insertion of a storage device into a slot of the local station so that the local station can copy the acquired digital audio file onto said storage device (e.g., CD, DVD, Memory Card, Memory Stick, Secure Digital (SD) card, Multimedia (MMC) card, Compact Flash card, Smart Media card, USB Flash Disk, Microdrive, . . . ), or (d) the local station copying the acquired digital audio file onto a storage device (e.g., a CD, DVD, Memory Card, Memory Stick, Secure Digital (SD) card, Multimedia (MMC) card, Compact Flash card, Smart Media card, USB Flash Disk, Microdrive) that was harbored inside the local station (i.e., not inserted by the consumer) and releasing said storage device to the consumer.

In yet another embodiment, the consumer can gain access to digital audio content via his/her cellular phone, smart phone or cell phone enabled PDA. For example, the consumer can send a text message specifying the digital audio file s/he wants to purchase to a central server or similar entity, and then receive the specified digital audio file of the present invention via wireless transmission on his/her cell phone or any other device s/he might specify, e.g., e-mailing of the digital audio file to an e-mail address, or gaining access to the digital audio file via downloading from the Internet. Payment in such a setting can be verified and executed via a cellular phone bill.

Many different ways of implementing the system and/or method of our invention will come to the mind of the artist, and the implementation of the system and/or method should not limit the scope of the invention. Particularly, any of the embodiments laid out before can be combined, e.g., downloading digital audio files of the invention on a computer via the internet, but payment via a cellular phone, or purchasing a digital audio file of the invention on a local station, but gaining access to said digital audio file by receiving an e-mail having said digital audio file as an attachment, . . . Yet, all systems have in common that the digital audio file of the invention will be transferred in the end either directly or indirectly to a decoding device for playback or reproduction.

In summary, the system and method of the present invention provides a novel, useful and non-obvious business model for generating additional revenues from selling and/or distributing digital audio files by incorporating at least one advertisement message part in addition to the music entertainment part(s).

(2) Advantages of the Invention Over Prior Approaches (Novel; Non-Obvious; Useful)

As outlined above and in more detail in the following paragraphs, the present invention fulfills the patent bar: It is novel, non-obvious, and useful.

(2.1) Usefulness

The present invention will be of use to many parties: (A) The music industry, which comprises (A.1) the distributors/sellers of digital music content (e.g., iTunes, MusicMatch, . . . ); (A.2) the owners of digital music content (e.g., Sony BMG, Virgin EMI, Warner Music Group, Universal, . . . ); (A.3) the artists or creators of digital music content (e.g., U2, Rolling Stones, Moby, Britney Spears, etc.). (B) Other industries: (B.1) The advertising industry (e.g., producers of advertisement messages); (B.2) industries purchasing or using advertisement message parts (e.g., Coca-Cola; McDonald's; Burger King; Wal-Mart). (C) The consumers of music.

Music Industry: Distributors and/or Sellers of Digital Music Content (Apple's iTunes, Roxio's Napster, . . . ) (A.1): The present invention will allow the distributors and/or (retail) sellers of digital music content to offer digital music single tracks at a lower price, because—by applying our invention—they will have an additional revenues stream through the incorporation of the advertisement message part. Thus, through optimal pricing, they can increase profits (by selling proportionately more songs at a lower price) and/or gain market share in this newly, but potentially highly lucrative business of digital musical content download. Assuming $0.88 as the fully absorbed cost to offer a song for digital download, a seller of digital music content could lower the price even further if s/he incorporates an advertisement message part, and thus creates a competitive advantage in terms of price.

Music Industry: the Owners of Digital Music Content (Sony BMG, Virgin EMI, Warner Music Group, . . . ) (A.2): The present invention is also useful for the owners of digital audio or music content: By having a lower retail sales price on digital audio (music) through linking of a music entertainment part with an advertisement message part, more consumers will prefer the legal acquisition (e.g., download) to illegal acquisition (e.g., file sharing services). And the owners of music content (“wholesalers”) might be able to still charge the same licensing or royalty fees to the one's of iTunes and MusicMatch (“retailers”), thus increasing their profit (selling more digital audio files wholesale to the distributors or sellers of digital music content at the same price). Alternatively, the owners of digital music content might prefer to directly sell digital audio files of the present invention to consumers themselves.

Music industry: the artists or creators of digital music content (A.3): The present invention will also prove useful for the artists, i.e., the creators of music. As many artists share in the revenues of their record sales and music downloads, illegal acquisition (e.g., by downloading from file sharing services) also lowers the revenues and profit artists can reap from their creative activity in composing and producing music entertainment. Moreover, if illegal downloading became “the standard”, new, less known or unknown artists would find it the more difficult to get a (first) record deal: Interest to invest in novel artists would be extremely low as there would be no or only low profits to be made, and in most instances, the high upfront investment cost to produce and market an album and/or the artist would make it generally a negative Net Present Value project.

Other industries: advertising industry (B.1) Moreover, our invention is also of use for the advertising industry: It opens a new advertising outlet so that advertising companies can grow revenues or gain market share.

Other industries: Industries purchasing or using advertisement message parts (B.2): Industries placing advertisement message parts linked to music entertainment parts will be able to raise awareness of their products, which makes our invention useful to that group as well. And given that this form of advertising is new, it will induce more consumers to respond positively to the advertisement message part as there is less clutter (background noise). In addition, the consumer will associate the advertisement message part with the song, and even if s/he is listening to the song without the advertisement message part, s/he might associate the song with the advertised product, which further increases the value of the advertisement message part linked to said song in some channels. Last, music consumers belong primarily to the age 18 to 45 demographic group, which is one of the prime targets for advertisement messages. Moreover, those within this demographic that prefer the legal download, might be better situated and spend more money in general, and thus also on the advertised products.

Consumers (C): Last, but not least, also the consumers will profit in several ways from our invention: They can acquire digital music entertainment (e.g., songs, singles) at a lower price if purchased linked to the advertisement message part. Moreover, by refraining from illegal downloading and paying a fair share to the whole music value chain, all parts of the value chain are incentivized to produce more and novel music, which in the end increases the offering for the consumer. Last, the advertisement message part will provide in some instances useful information for the consumers by educating them about new products, services or offerings. Thus, whereas the consumer might be primarily interested in acquiring the music entertainment part, the advertisement message part provides at least three advantages to the user as well:

(1) It provides useful information to the consumer by raising awareness and educating the consumer of products and services.

(2) The advertisement message part might allow the seller or distributor to sell or distribute the music entertainment part in combination with the advertisement message part at a lower price than selling or distributing the music entertainment part on its own. The customer directly profits from that lower price by having to spend less money to obtain access to the desired music entertainment part.

(3) The whole music industry value chain will be incentivized to create new music, such expanding the product offering and choice for the consumer.

Moreover, compared to prior art, another advantage and improvement of the present invention is the fact that removing the advertisement message part from the digital audio files of the present invention is rather complicated as both the advertisement message part and the music entertainment part are digital audio data and part of the same file. If a consumer tried to remove the advertisement message part, it could lead to irreparable damage to the digital audio file. Thus, the consumer might prefer to listen to the advertisement message part in order not to risk damaging the file.

(2.2) Novelty

The present invention is novel and distinct from prior art in many aspects, as already initially outlined in “Description of Prior Art”. Our invention relates to a method and system for selling and/or distributing digital audio files comprising at least one advertisement message part in addition to the music entertainment part. By incorporating an advertisement message part, digital audio files can be sold at a lower price due to additional advertising revenues, which in turn will induce more consumers to legally purchase digital audio files, thus potentially increasing overall revenues for the creators, owners, sellers, and/or distributors of digital audio content.

Similar methods have proven successful in other industries such as television (local channels which interrupt their shows to air advertisements in order to offer free content to their viewers), but have not yet been applied to the download or (more generally) distribution of digital audio files. Moreover, the system of the present invention has not yet been implemented or described in prior art.

How to generate digital audio content per se is already in the public domain and has been described in prior art, and thus, is not claimed as part of this invention. Moreover, one of ordinary skill in the art will be able to convert one digital audio format into another digital audio format without undue effort. Additionally, one of ordinary skill in the art will be able to combine, couple, or link the advertisement message part with the music entertainment part without undue effort. Besides, how to produce an advertisement message per se and how to produce music entertainment per se is also in the public domain, and thus not claimed in the present invention.

Whereas systems and methods to create, distribute and/or sell digital audio files have been established, none of those systems to our knowledge offers digital audio files comprising an advertisement message part in addition to the music entertainment part according to the claims of the present invention.

The advertisement message part and the music entertainment part are both (digital) audio data. In its preferred embodiment, the advertisement message part and the music entertainment part are played sequentially, i.e., without temporary overlap and without the advertisement message part interrupting the music entertainment part. In such a setting, the advertisement message part preferentially precedes the music entertainment part, but may also be played back once the music entertainment part has finished. This is one of the differentiators towards prior art U.S. Pat. No. 6,351,736. Moreover, U.S. Pat. No. 6,351,736 claims two different types of data, whereas we claim one type of data, a distinctive advancement and improvement in the art of conducting business (a more detailed analysis of prior art U.S. Pat. No. 6,351,736 can be found in the section “Description of Prior Art”).

(2.3) Non-Obviousness

The present invention is not obvious as previously outlined and described in more detail in the following paragraphs.

Obviously, several commercial services for the download of digital music content do exist (e.g., Apple's iTunes, Roxio's Napster, RealNetworks' RealOneRhapsody, MP3 Entertainment, MusicMatch, EMusic, Wippit, Full Audio's Music Now, AOL's Music Net, Burn It First). However, none of these services has offered yet digital audio files comprising an advertisement message part in addition to the music entertainment part. And whereas similar strategies of combining entertainment content with advertisement messages have proven successful in other industries such as television (local channels which interrupt their shows to air advertisements in order to offer free content to their viewers), it has not yet seemed obvious to the general artist to apply the same principles to the download or (more generally) distribution of digital audio files.

Even prior art patent No. 6,351,736 claims two different types of data where one data type (video) does not interfere with the other data type (audio). Thus, it does not seem obvious to those skilled in the art to use the same type of data (audio data) and interfere with the enjoyment of the music entertainment part. In deed all else equal consumers will prefer to purchase digital music content without advertisement message parts. However, which might not be obvious to the general artisan, is that “all else” does not have to be equal when incorporating an advertisement message part: The digital music content can be offered at a lower price, and the consumer gets indirectly paid for listening to the advertisement message part (as s/he has to pay less money to get access to the music entertainment part).

### DETAILED DESCRIPTION

The advent of audio compression algorithms such as the MPEG-3 decoder in combination with high-speed Internet access has enabled consumers to download digital audio files such as music single tracks from the Internet within minutes to seconds. Whereas legitimate service providers offer music files for download on payment such as Apple's iTunes, many consumers download music files illegally at no direct cost by using file sharing or similar services. This leads to a potential loss in revenues for the creators, owners, sellers, and/or distributors of digital audio content.

The present invention relates to a method and system for selling and/or distributing digital audio files comprising at least one advertisement message part in addition to the music entertainment part. By incorporating an advertisement message part, digital audio files can be sold at a lower price due to additional advertising revenues, which in turn will induce more consumers to legally purchase digital audio files, thus potentially increasing overall revenues for the creators, owners, sellers, and/or distributors of digital audio content.

It must be noted that as used herein and in the appended claims, the singular forms “a” and “the” include plural referents unless the context clearly dictates otherwise. Thus, for example, reference to “a file” or “the file” includes a plurality (“files” or “the files”), and so forth. In particular, reference to “an advertisement message part” or “the advertisement message part” includes a plurality (“advertisement message parts”, “the advertisement message parts”), unless the context clearly dictates otherwise. Moreover, the word “or” can either be exclusive in nature (i.e., either A or B, but not A and B together), or inclusive in nature (A or B, including A alone, B alone, but also A and B together) unless the context clearly dictates otherwise. One of skill in the art will realize which interpretation is the most appropriate unless it is detailed by reference in the text as “either A or B” (exclusive “or”) or “and/or” (inclusive “or”). Last, the use of “he” or “his” in reference to a human being or animal is not necessarily an indicator of male gender, but might refer to a female as well unless the context clearly dictates otherwise. For example, “the user activates his account” should not lead to the conclusion that the user is a male; rather, the sentence should include the meaning “the user activates her account” as well.

Definitions

For purposes of this invention, the term “coupled”, “couple”, “combined”, “combine”, “spliced”, “splice”, “linked” or “link” refers to a link between the advertisement message part and the music entertainment part. The link represents the means by which the advertisement message part and the music entertainment part are integrated into the digital audio file so that both parts are reproduced or played together on a decoding or playback device once a decoding or playback is initialized by a user, hardware, or software. The link can be established in a way that the advertisement message part precedes, interrupts, follows or overlaps with the music entertainment part. The link can also be established in a way that the advertisement message part is overlaid on the music entertainment part. More than one advertisement message part can be linked to the same music entertainment part with said advertisement message part(s) being either identical or not identical. More than one music entertainment part can be linked with one advertisement message part. Furthermore, more than one music entertainment part can be linked with more than one advertisement message part with the music entertainment part(s) being either identical or not identical, and/or with the advertisement message part(s) being either identical or not identical.

For purposes of this invention, the term “audio data” refers to data that encodes sound information. Audio data can encode music, spoken words, noise or any other form of sound. In its preferred embodiment, “audio” or “audio data” encode or refer to music.

For purposes of this invention, the term “file” or “data file” means a set of related electronic records kept together. A record can be anything (such as a document or a phonograph record or a photograph) providing permanent evidence of or information about past events.

For purposes of this invention, the term “audio” means any form of audible sound, be it music, spoken words, noise or any other form of audible sound. More generally, “audio” means the audible part of a transmitted signal or the audible acoustic wave frequency. For purposes of this invention, the term “sound” means a particular auditory effect produced by a given cause; it is mediated by mechanical vibrations transmitted by an elastic medium.

For purposes of this invention, the term “data” means digitally stored information.

For purposes of this invention, the term “consumer” means a legal person or living being, preferentially a human being acquiring, purchasing and/or using a certain good or service. Moreover, the term “consumer” also means a legal person or living being, preferentially a human being who intends to acquire, purchase and/or use a certain good or service. The term “music consumer” refers to a consumer who acquires, purchases and/or uses music, or who intends to acquire, purchase and/or use music. A company, corporation or legal entity is a special form of a consumer.

For purposes of this invention, the term “user” refers to a legal person or living being, preferentially a human being, who interacts with the system of the present invention.

For purposes of this invention, the term “decoding device” means any device or means that can be used to play or reproduce digital audio content in general, and digital music content in particular. It generally comprises a hardware component and software component. The hardware component (“hardware device”) can be without limitation a desktop computer, laptop, hand-held device, PDA, Palm Pilot, Pocket PC, Tablet PC, digital photo camera, digital video camera, digital music player, portable audio player, (digital) DVD player, CD player, video gaming console and/or a cellular phone. A large variety of software components are already in the public domain such as “MusicMatch Jukebox”, “Windows Media Player”, “WinAMP”, “iTunes”, “Napster”, “RealOne Player”, etc. A “decoding device” is a special form of a computer. In many instances, the decoding device also comprises a storage component apart from the hardware and software component. The storage component harbors the digital audio files. The storage component can be either a physical part of the decoding device (as in case of Apple's iPod), or it can be a separate entity such as a CD, DVD, Memory Card, Memory Stick, Secure Digital (SD) card, Multimedia (MMC) card, Compact Flash card, Smart Media card, USB Flash Disk, Microdrive (as in case of Casio's Exilim EX-M20 that accepts SD and MMC cards). The choice of decoding device used to reproduce the digital audio file does not limit the scope or the spirit of this invention.

For purposes of this invention, the term “digital audio format” refers to a file format selected from at least one of the following file formats: MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, MIDI, WAV, or any other digital format or electronic music distribution (EMD) system.

For purposes of this invention, the term “digital music player” or “digital audio player” refers to a “decoding device” whose main (but not necessarily sole) purpose is the reproduction and/or playback of digital audio files. Thus, a digital music player is a special form of a decoding device, and thus also a special form of a computer. Preferentially, the digital music player is portable. Examples of digital music players are Apple's iPod, Rio S35S Sport Digital Audio Player, iRiver iFP-190T 256 MB Digital Audio Player, Creative Labs Nomad Jukebox Zen Xtra 30 GB MP3 Player, iRiver iHP-120 20 GB MP3 Jukebox, Creative Labs Muvo NX 256 MB MP3 Player, Samsung YP-N30S 64 MB Digital Audio Player, Nike Sport 128 MB MP3 Player, PANASONIC SV-SD80 e-wear SD Audio Player. The digital music player stores the digital audio files either “locally” (built-in memory) on a storage component such as a hard drive (e.g., Apple's iPod, iRiver Jukebox, Creative Labs Nomad Jukebox Zen Xtra, Nike Sport 128 MB MP3 Player); alternatively, the digital music player can accept an external storage component (such as for example CDs, DVDs, Memory Cards, Memory Sticks, Secure Digital (SD) cards, Multimedia (MMC) cards, Compact Flash cards, Smart Media cards, USB Flash Disks, Microdrives etc.), on which the digital audio files are stored. Examples of digital music players accepting external storage devices (external memory) are Casio's Exilim EX-M20, Rio S35S Sport Digital Audio Player, PANASONIC SV-SD80 e-wear SD Audio Player. An MP3 player is a special form of a digital music player that is capable of decoding MP3 files. However, an MP3 player might be able to decode other formats besides the MP3 format. Sometimes, the term “MP3 player” is used to refer to a digital music player in general (“pars pro toto”).

For purposes of this invention, the term “advertisement”, “advertisement message, “advertisement message part” refers to promotional data for promoting a particular product, service, individual, group, company, organization, brand, entity, event or other promoted item.

For purposes of this invention, the term “Web browser” refers to any software program which can display text, graphics, or both, from Web pages on World Wide Web sites and/or from data stored locally to the computer of the user. Hereinafter, the term “Web page” refers to any document written in a mark-up language including, but not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator). Hereinafter, the term “Web site” refers to at least one Web page, and preferably a plurality of Web pages, virtually connected to form a coherent group. Hereinafter, the term “Web server” refers to a computer or other electronic device which is capable of serving at least one Web page to a Web browser.

For purposes of this invention, the term “network” refers to a connection between any two computers which permits the transmission of data. The Internet is a special form of a network. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages. Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems. The World Wide Web is especially conducive to conducting electronic commerce. Many Web servers have been developed through which vendors can advertise and sell products. The products can include items (e.g., digital audio or music files, including those of the present invention) that are delivered electronically to the purchaser over the Internet and items (e.g., books or digital audio or music files, including those of the present invention, stored on a physical storage device such as a CD) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming Web page to the client computer system and schedules shipment of the items.

For purposes of this invention, the term “local station” or “local computer station” means a physical point of sales of digital audio files, including those of the present invention. A local station can be located in music stores, grocery stores, bookstores, gas stations or at any other location. In its preferred embodiments, the local station is operative without requiring the permanent presence of a human being such as a sales agent. In its preferred embodiments, the local station can be either a stand-alone computer system or a computer system remotely linked to a server. The local station mediates access to digital audio files of the present invention by (a) having said digital audio files stored locally (e.g., on a hard drive or other storage device inside said local station) or by (b) having a network connection to a remote server with said server having stored the digital audio files of the present invention, or (c) any other technically feasible means. Either the local station or a remote server will verify if the consumer has the right to acquire or receive delivery of a particular digital audio file, either by verifying payment (cash; credit card; debit card; coupon; prepaid card) or by any other means. Upon successful verification, the consumer then can access (receive delivery of) the digital audio file s/he selected (ordered) by any means technically feasible such as without limitation (a) direct or indirect download (from the local station or from a remote server via the Internet; or via e-mail), (b) wireless transmission (via IR (Infrared); Bluetooth (Version 1 or 2); WiFi; 802.11a/b/g; GSM 900/1800/1900, GPRS, E-GPRS, EDGE, HSCSD, CSD, CDMA, UMTS and 3G networks; etc.) to his/her computing device, storage device, decoding device or cellular phone, (c) insertion of a storage device into a slot of the local station so that the local station can copy the acquired digital audio file onto said storage device (e.g., a CD, DVD, Memory Card, Memory Stick, Secure Digital (SD) card, Multimedia (MMC) card, Compact Flash card, Smart Media card, USB Flash Disk, Microdrive), or (d) the local station copying the acquired digital audio file onto a storage device (e.g., a CD, DVD, Memory Card, Memory Stick, Secure Digital (SD) card, Multimedia (MMC) card, Compact Flash card, Smart Media card, USB Flash Disk, Microdrive etc.) that was harbored inside the local station (i.e., not inserted by the consumer) and releasing said storage device to the consumer.

For purposes of this invention, the term “download” refers in general to the transfer of data or (especially) code from one computer or computing device (including cellular phones) to another computer or computing device (including cellular phones). Downloading often refers to transfer from a larger “host” system (especially a server or mainframe) to a smaller “client” system, especially a microcomputer or specialized peripheral. In particular, the term “download” refers to the transfer of a copy of a file residing on a remote computer to a user's computer or computing device. Transfer can be achieved via a network such as the Internet or an intranet. For purposes of this invention, the term “download” would also encompass transfer of a digital audio file of the present invention to an external storage device (e.g., a CD, DVD, Memory Card, Memory Stick, Secure Digital (SD) card, Multimedia (MMC) card, Compact Flash card, Smart Media card, USB Flash Disk, Microdrive etc.) as well as transfer of a digital audio file of the present invention to any decoding device and/or digital audio player and/or digital music player. For example, the term “download” according to the present invention would include the “burning” of a song to a CD, as it is offered for example by RealOneRhapsody as of the date of filing of this patent.

For purposes of this invention, the term “digital audio file of the present invention” or “digital audio file of the invention” refers to a digital audio file comprising at least one advertisement message part and at least one music entertainment part as outlined in the claims in general, and in claims 1 and 24 in particular.

General Methods

The advent of audio compression algorithms such as the MPEG-3 decoder in combination with high-speed Internet access has enabled consumers to download digital audio files such as music single tracks from the Internet within seconds to minutes. Whereas legitimate service providers offer music files for download on payment such as Apple's iTunes, many consumers download music files illegally at no direct cost by using file sharing or similar services. This leads to a potential loss in revenues for the creators, owners, sellers, and distributors of digital audio content.

The present invention relates to a method and system for selling and/or distributing digital audio files comprising at least one advertisement message part in addition to at least one music entertainment part. By incorporating an advertisement message part, digital audio files can be sold at a lower price due to additional advertising revenues, which in turn will induce more consumers to legally purchase digital audio files, thus potentially increasing overall revenues for the creators, owners, sellers, and/or distributors of digital audio content.

The advertisement message part and the music entertainment part are both audio data. In its preferred embodiment, the advertisement message part and the music entertainment part are played sequentially, i.e., without temporary overlap and without the advertisement message part interrupting the music entertainment part. In such a setting, the advertisement message part preferentially precedes the music entertainment part, but may also be played back once the music entertainment part has finished.

How to generate digital audio content is already in the public domain, and thus, not claimed as part of this invention. Please also refer to the documents listed in prior art, which will support the enablement of the present invention. One of ordinary skill in the art will be able to convert one digital audio format into another digital audio format without undue effort. Additionally, one of ordinary skill in the art will be able to combine, couple, splice, or link advertisement message part(s) with music entertainment part(s) without undue effort. For example, one of skill in the art can record and arrange music using sequencing and music production software, such as without limitation Logic Audio, Cakewalk Home Studio 2004 XL, VS Pro Tool Box, Studio Case, Cubase SL, Sonar Studio Edition, Sonar Producer Edition, Spark XL, Samplitude Professional, Cubase SX 2.0, Sibelius.

Composition programs include sequencers, scorewriters, auto-accompaniment, and integrated programs. They can be thought of as musical word processors that allow the user to record, edit, arrange and publish music. These “music processors” share many common features: Most will allow the user to edit, copy, cut and paste music; record from a MIDI keyboard; transpose; and print. This technology enables anyone to create and edit his or her own music, and thus practice the present invention.

Most sequencers allow the user to start and stop at any point, change tempos, instruments, solo and mute parts and even transpose on the fly. There are two types of musical data that a sequencer can use: MIDI and Audio. Once one has recorded music using a keyboard, microphone or guitar, one can edit and arrange it, e.g., add parts, delete parts, transpose parts, change the tempo, etc. Sequencers usually can create a .wav or .aiff file for burning a CD, or some will even create directly MP3 or Real Audio files. Alternatively, .wav files can be converted into compression formats such as MP3 using other commercially available software or freeware (e.g., MusicMatch). Of course, one can always save his/her work as a MIDI file. MIDI data tells a computer what notes to play when. It does not tell the computer how the notes sound. It is up to the soundcard or synthesizer to create the sound, therefore a MIDI file will sound differently on different computers. The advantage of MIDI is that it is very easy to edit and has a very small file size. Audio data on the other hand tells a computer exactly how the music sounds. It does not “tell” the computer what the notes are or what instrument is playing. The data will always sound the same, no matter what computer is used. If one wants to make a CD, at some point one has to convert music into a wave file on the PC or an AIFF file on the Mac. All MIDI data will need to be converted to audio data. It is usually the last step in the process.

Although the difference between a sequencer and a notation program has become muddied over the years, a sequencer is mostly concerned with how music sounds. In other words, a sequencer is a tool for recording, editing and arranging music. The first sequencers did not even have a notation view that allowed you to look at traditional music. Instead, one had to work with a graphical roll view. Although most sequencers let the user view and print notation, they are usually very limited in terms of page layout and markings.

Sequencers have traditionally been more flexible when it comes to recording in real time. Advanced features such as tempo maps allow the artisan to set-up the tempo and changes ahead of time. Some scorewriters are starting to adopt this flexibility, such as Sibelius's “flexi-time” recording that follows the artist's tempo. Another strength found in most sequencers is the ability to quantize (line up the rhythms) music in a number of different ways. For example, one can define a “groove” or pattern that most rhythms should line up to, and then choose a percentage of how close the notes should be to the groove.

Notation programs (or scorewriters) put the emphasis on how the music looks. They provide more flexible page layout and publishing control. However, scorewriters sometimes lack advanced playback control, quantizing and other features that are focused on how the music sounds. Many companies are starting to include many of these basic features that were once lacking. Some developers are even starting to add artificial intelligence to playback, such as Sibelius's “expressive” feature. There are a few programs that attempt to integrate sequencing and notation into one package. Cubase SX, for example, integrates the most common sequencer features, while including flexible notation and page layout options.

There are four main ways to enter music with most software packages: recording in real time, step entry, mouse or keyboard entry and scanning. Real time recording in music is similar to speech recognition in word processing: Although it is the most natural way to enter data, it also requires some adjustments on the part of the user, and the technology. The artisan can record directly to the computer from a MIDI keyboard through a MIDI interface. The keyboard can be as simple as an inexpensive 49 key controller, to a 64 voice synthesizer to an 88 key electronic piano with weighted action. If one has no access to a MIDI keyboard, some software allows the user to use a computer keyboard to record in real time, provided one does not try to access a range larger than an octave. Most notation programs allow the user to control the level of quantization both before and after recording. It is wise to set the quantization to the shortest note value to be played. Quantizing to eighth notes, for example, will prevent the program from notating staccato eights as dotted sixteenths. Some programs such as Finale allow the user to tap the tempo as s/he plays. Others, such as Sibelius, will attempt to follow the artist if s/he gradually changes tempo.

Traditionally, composition software has been the exclusive domain of MIDI. It is relatively easy for an electronic keyboard or even a guitar to send note on and off messages for the computer to record. Until recently, the options for non-keyboard players were to avoid real-time recording, or buy expensive pitch to MIDI converters. MakeMusic's family of products (Print Music, Finale, etc.) will convert single melodic lines to MIDI in real-time. This allows the artisan with a microphone to sing or play into virtually any sequencer or notation program. However, the technology is still in its infancy, and it is difficult for a computer to identify the fundamental pitch when dealing with the overtones produced by complex waveforms such as guitar.

In many cases it is difficult to enter music in real-time, even with the tempo lowered. Step-entry is an efficient alternative that allows the pitch to be selected by playing a note on the MIDI keyboard, while the rhythmic value is manually entered. Many programs, for example, have a palette of note values that one can click to select. Using the keyboard, however, is usually faster Sibelius, for example maps the numeric key pad to specific note values. Finale also includes a quick reference sheet that lets you use the keyboard for speedy entry.

In addition to step-entry, one can enter pitches by clicking them on the staff or tapping their corresponding key on the keyboard. This is useful for situations where a MIDI keyboard is not available. On-screen keyboards or guitar fretboards are also available in some programs and can be used for step-entry or for real-time entry, provided the artisan can move his/her mouse fast enough.

Another option for inputting music into the computer is through optical character recognition. Programs such as SmartScore or Photoscore allow users to scan music for further editing.

The latest versions of Sibelius and Finale now include their own built in “soft synth” and “convert to wave” features that improve the sound quality of your playback and allow you to burn it to CD. However, for more professional playback, a sequencer with a VST or DXi soft synth will provide much better results. There are a number of extremely high quality soft synths and sample libraries that can make one's music sound very realistic.

Prior art also explains a digital encoding and decoding process for transmitting and/or storing acoustical signals and, in particular, music signals. The procedure with encoding processes for transmitting and/or storing acoustical signals and, in particular, music signals is usually as follows: First the scanned values of the acoustical signal are transformed into a sequence of second scanned values reproducing the spectral composition of the acoustical signal. This sequence of second scanned values is then quantized with varying precision and partially or completely encoded using an optimal encoder depending on the requirements. In reproduction, a corresponding decoding and reverse transformation takes place.

### DETAILED DESCRIPTION OF THE PREFERRED EMBODIMENTS

The principles and operation of a system and a method according to the present invention may be better understood with reference to the accompanying description, it being understood that these examples and embodiments are given for illustrative purposes only and are not meant to be limiting.

In all embodiments, the advertisement message part(s) and the music entertainment part(s) are both audio data and are both part of the same digital audio file. The advertisement message part(s) and music entertainment part(s) in all embodiments are linked in such a way that they are acquired and/or accessed as one file by the consumer whereas the method of acquisition can be without limitation download from the Internet or any other network, purchase of a storage device harboring said digital audio file, copy of said digital audio file to a storage device, (wired or wireless) transmission of said digital audio file to a decoding device.

The system and method of the present invention essentially comprises the following five steps: (1) Creation or arrangement of the digital audio file comprising at least one advertisement message part and at least one music entertainment part. (2) Selection and order of a digital audio file (of the present invention) by the consumer. (3) Payment for the digital audio file (of the present invention) by the consumer. (4) Delivery of the digital audio file of the present invention to the consumer, or (generally speaking) granting access to the digital audio file of the present invention to the consumer. (5) Decoding of the digital audio file of the present invention via a decoding device by the consumer.

It has to be noted that steps (1) to (5) can be in any order; whereas in most embodiments, step 1 will be the first step, in some embodiments, a consumer might pay for a song first (step 3), then select a song (step 2), and then get said song delivered (step 4). In other embodiments, the song can be delivered before the consumer pays.

To Step 1: In preferred embodiments, the advertisement message part and the music entertainment part are arranged and thus reproduced (played back) sequentially, i.e., without temporary overlap and without the advertisement message part interrupting the music entertainment part. In such a setting, the advertisement message part preferentially precedes the music entertainment part, but may also be played back once the music entertainment part has finished. Moreover, in its preferred embodiment, the digital audio file comprises exactly one advertisement message part and exactly one music entertainment part.

The advertisement message part preferentially takes less than 5 seconds, less preferentially between 5 and 10 seconds and least preferentially more than 10 seconds. The advertisement message part can promote without limitation physical products (e.g., food, drugs, beverages, cars, tobacco), services (e.g., banking, financial services, travel, leisure activities, phone service, wireless service, cable service), companies or brands (e.g., Pepsi, Coca-Cola, McDonald's, Burger King, Ford, Chrysler), institutions or corporations, entertainment content (e.g., movies, television shows, music), persons, individuals, groups, entities or events. The advertisement message part might also give advice or refer to a web site for further information or product acquisition. The advertisement message part might refer to a promoted item either directly or indirectly using a jingle or voice or music branding. The music entertainment part preferentially is a digital audio format of a single or track that is or was listed on the Billboard Hot 100 single charts or Top 40 tracks.

One example of the preferred embodiment would be the following digital audio file: A digital audio file that reproduces an advertisement message part stating as a voice message: “The following song is brought to you by Pepsi. Enjoy!”, directly followed by the song (music entertainment part) “Yesterday” from “The Beatles”. Another example would be the T-Mobile jingle (as advertisement message part) followed by the song (music entertainment part) “I just called to say I love you” from Stevie Wonder.

In other embodiments, a short advertisement message part follows the music entertainment part. An example for said embodiments is the following digital audio file: A digital audio file that reproduces the song (music entertainment part) “Yesterday” from “The Beatles”, followed by an advertisement message part stating as a voice message: “This song was brought to you by Pepsi: Not so yesterday at all. “. Another example would be the song (music entertainment part) “I just called to say I love you” from Stevie Wonder, followed by the T-Mobile jingle (as advertisement message part). Yet another example would be the song (music entertainment part) “I just called to say I love you” from Stevie Wonder followed by the Verizon Wireless logo line (as advertisement message part) “Can you hear me now?”.

In yet other embodiments, the advertisement message part interrupts the music entertainment part. An example for said embodiments is the following digital audio file: A digital audio file that reproduces for 60 seconds the beginning of the song (music entertainment part) “Shut Up” from Black Eyed Peas, then reproduces the Verizon Wireless logo line (advertisement message part) “Can you hear me now?”, followed by the remaining (second) part of the song (music entertainment part) “Shut up”. In some embodiments, the second part of the song can be preceded by some portion of the first part of the song.

In less preferred embodiments of the present invention, the advertisement message part is reproduced as an overlay to the music entertainment part, i.e., the advertisement message part and the music entertainment part are played or reproduced at the same time. In such a setting, the advertisement message part preferentially is very short in terms of time (preferentially less than 5 seconds) and is preferentially placed at a position where there is no human voice reproduced in the music entertainment part. Overlay can be achieved for example by decreasing the volume of the music entertainment part relative to the advertisement message part.

In yet other embodiments, the advertisement message part and the music entertainment part overlap; in such a setting, one embodiment could entail that the advertisement message part precedes the music entertainment part, but the last part of the advertisement message part overlaps or is overlaid with the beginning of the music entertainment part.

In yet other embodiments, more than one advertisement message part is linked to the (same) music entertainment part. In such instances, the advertisement message part might be the same (i.e., repeated), or several different advertisement message parts are linked to the same music entertainment part. An example for said embodiments is the following digital audio file: A digital audio file that reproduces a first advertisement message part stating as a voice message: “The following song is brought to you by Pepsi. Enjoy!”, followed by the song (music entertainment part) “Yesterday” from “The Beatles”, followed by the voice message (second advertisement message part): “This song was brought to you by Pepsi: Not so yesterday at all.”. Another example for said embodiments is the following digital audio file: A digital audio file that reproduces a first advertisement message part reproducing the McDonald's jingle: “McDonald's: I'm lovin' it”, followed by the song (music entertainment part) “Rock your body” from Justin Timberlake, followed by the voice message (second advertisement message part): “This song was brought to you by Coca-Cola: The Coke that rocks your world “. Another example for said embodiments is the following digital audio file: A digital audio file that reproduces the Verizon Wireless logo line (first advertisement message part) “Can you hear me now?”, followed by the song (music entertainment part) “Rock your body” from Justin Timberlake, followed by the voice message (second advertisement message part): “This song was brought to you by Coca-Cola: The Coke that rocks your world”.

In yet other embodiments, one advertisement message part is linked to more than one music entertainment part. In such instances, the advertisement message preferentially is located between two music entertainment parts. An example for said embodiments is the following digital audio file: A digital audio file that reproduces the song (first music entertainment part) “Rock your body” from Justin Timberlake, followed by the voice message (advertisement message part): “Pepsi: Enjoy the taste”, followed by the song (second music entertainment part) “Everytime” from Britney Spears.

In yet other embodiments, more than one advertisement message part is linked to more than one music entertainment part. An example for said embodiments is the following digital audio file: A digital audio file that reproduces the Verizon Wireless logo line (first advertisement message part) “Can you hear me now?”, followed by the song (first music entertainment part) “Rock your body” from Justin Timberlake, followed by the voice message (second advertisement message part): “Pepsi: Enjoy the taste”, followed by the song (second music entertainment part) “Everytime” from Britney Spears.

Several combinations and arrangements for the advertisement message part and the music entertainment part might come to the mind of the artisan and do not limit the scope or spirit of this invention.

How to arrange and link the advertisement message part(s) and the music entertainment part(s) is explained in prior art and in “General Methods”. Also, the file format of the digital audio file comprising the advertisement message part and music entertainment part does not limit the scope or spirit of this invention. File formats used for digital audio data are without limitation MP3, WMA, WAV, MIDI. Music contents can be distributed by a plurality of EMD systems (Electronic Music Distribution systems) and adopt various audio compression schemes: MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, and the like.

To Step 2: Many systems and methods for selecting and ordering digital audio files are already in the public domain (see for example Apple's iTunes, Roxio's Napster, RealNetworks' RealOneRhapsody, MP3 Entertainment, MusicMatch, EMusic, Wippit, Full Audio's Music Now, AOL's Music Net, Burn It First). Those systems can be used for the present invention to select and order digital audio files comprising at least one advertisement message part linked to at least one music entertainment part. The system and method of the present invention allows the consumer to select and/or order a digital audio file for acquisition, access or download where said digital audio file comprises at least one advertisement message part and at least one music entertainment part. Several systems can be implemented to achieve that goal, and the exact implementation chosen does not limit the scope or spirit of the present invention.

In its preferred embodiment, the consumer selects the digital audio file by entering some identifying information into a computer search engine or browser. Identifying information might be the title, composer or genre of the song s/he intends to acquire, access or download. Said computer search engine or browser can be located on a remote server and contacted via the Internet or any other network, or it can be part of a local station in a retail outlet or other location. Once the consumer has entered the information, the computer search engine or browser returns a list of potential digital audio files the consumer might want to order. Alternatively, the consumer might be presented with a pre-set list of songs to choose from, or an electric catalog with alphabetically ordered songs, or songs categorized by an alphabetical list of artists. The consumer then can highlight or mark or more generally select the digital audio file s/he wants to acquire, access or download and submit an order at a local station and/or electronically via the Internet or any other network.

In preferred embodiments, the consumer selects and/or orders the song via the Internet or any other network. In other embodiments, the consumer selects and/or orders the song via a wireless network such as wireless cellular phone networks such as GSM 900/1800/1900, GPRS, E-GPRS, EDGE, HSCSD, CSD, CDMA, UMTS and 3G networks. In those instances, the consumer might select and/or order the song by sending an MMS or SMS text message. In some embodiments, the consumer might even listen to a certain song, dial a number on a phone, transmit part of the song s/he is listening to a receiving entity, and place an order (specifying the song selected) by that means.

In less preferred embodiments, the consumer orders the digital audio file of the present invention by mail, e-mail or phone.

To Step 3: Many systems and methods for payment for digital audio files are already in the public domain (see for example Apple's iTunes, Roxio's Napster, RealNetworks' RealOneRhapsody, MP3 Entertainment, MusicMatch, EMusic, Wippit, Full Audio's Music Now, AOL's Music Net, Burn It First). Those or similar systems can be used for the present invention to pay for digital audio files comprising at least one advertisement message part linked to at least one music entertainment part. Several systems can be implemented to achieve that goal, and the exact implementation chosen does not limit the scope or spirit of the present invention.

In preferred embodiments, the consumer will pay for the digital audio file selected and ordered in step 2 after completion of step 2, before step 4. Payment preferentially will occur via debit or credit card. Alternatively, payment can also occur via check, cash or coupon. If the digital audio file is selected via the Internet, electronic payment (debit or credit card) is preferred. If the digital audio file is selected at a local station, cash or check payment represent alternative solutions.

In preferred embodiments, the consumer pays for each digital audio file of the present invention s/he acquires, accesses or downloads. Yet, in other embodiments, the consumer might pay a fixed amount per month and thus gain the right to receive delivery of, access or download a (pre)specified or unlimited number of digital audio files of the invention.

In embodiments, where selection, order, delivery and/or access takes place via a wireless cell phone network (e.g., GSM 900/1800/1900, GPRS, E-GPRS, EDGE, HSCSD, CSD, CDMA, UMTS and 3G networks), payment can also be performed by billing any charges to the consumer's cell phone bill.

To Step 4: Many systems and methods for delivery of or access to digital audio files are already in the public domain (see for example Apple's iTunes, Roxio's Napster, RealNetworks' RealOneRhapsody, MP3 Entertainment, MusicMatch, EMusic, Wippit, Full Audio's Music Now, AOL's Music Net, Burn It First). Those systems can be used for the present invention to deliver or grant access to digital audio files comprising at least one advertisement message part linked to at least one music entertainment part. Several systems can be implemented to achieve that goal, and the exact implementation chosen does not limit the scope or spirit of the present invention. Delivery might be executed either in hard copy or soft copy. In case of a soft copy delivery, said delivery can be either wired or wireless.

In preferred embodiments, delivery or access of the digital audio file of the present invention will be performed via download over the Internet or another network. In such a setting, the digital audio file can be stored on a central server and transferred from that server to the computer or decoding device of the consumer.

In other embodiments, delivery of or access to the digital audio file of the present invention will be performed via wireless transmission using cellular phone networks such as the GSM 900/1800/1900, GPRS, E-GPRS, EDGE, HSCSD, CSD, CDMA, UMTS and 3G networks. This delivery method is preferred if the consumer selected, ordered and/or paid for the digital audio file using his/her cellular phone or any other wireless device with cell phone functionality.

In yet other embodiments, delivery of the digital audio file of the present invention will be executed via e-mail where the digital audio file is attached as attachment to an e-mail message. When the file is attached, it might be transmitted in a standardized protocol such as Multi-Purpose Internet Mail Extensions (herein “MIME”). MIME is an extension of the original Internet e-mail protocol that lets people use the protocol to exchange different kinds of data files on the Internet: audio, video, images, application programs, and other kinds, as well as the ASCII handled in the original protocol, the Simple Mail Transport Protocol (SMTP). In 1991, Nathan Borenstein of Bellcore proposed to the Internet Engineering Task Force that SMTP be extended so that Internet (but mainly Web) clients and servers could recognize and handle other kinds of data than ASCII text. As a result, new file types were added to “mail” as a supported Internet Protocol file type.

In yet other embodiments, delivery of the digital audio file of the present invention will be executed in hard copy. In these embodiments, the digital audio file will be delivered stored on a storage device such as without limitation a CD, DVD, Memory Card, Memory Stick, Secure Digital (SD) card, Multimedia (MMC) card, Compact Flash card, Smart Media card, USB Flash Disk, Microdrive. Said storage device can be delivered by mail, purchased in a store, or received by a local station. In case of a local station, the local station can either dispense a storage device containing the selected and ordered digital audio file, or alternatively, the consumer inserts an appropriate storage device into the local station so that the local station can store a copy of the selected and ordered digital audio file onto the consumer's storage device.

In its preferred embodiments, the delivery comprises transfer of the digital audio file of the present invention from a central server to the consumer's computer or decoding device. In these embodiments, the transfer can be performed via the Internet or any other, functionally similar network. Alternatively, the transfer can be performed via wireless (cell phone) networks or via short-range local Wi Fi, 802.11a/b/g or Bluetooth networks. WiFi, 802.11a/b/g and/or Bluetooth networks are particularly of interest in instances where the digital audio file of the present invention is purchased at a local station. Said station might have a connection to a central server and function merely as an intermediate network node. In other embodiments, said station stores the digital audio files of the present invention locally.

To Step 5: Once the consumer has acquired, downloaded and/or been granted access to the digital audio file of the present invention, s/he can playback said file using a decoding device as defined above. As the advertisement message part and the music entertainment part are integrated into the same digital audio file, both parts are reproduced or played together on a decoding or playback device once a decoding or playback is initialized by a user, hardware, or software. Thus, when a consumer acquires, accesses or downloads a digital audio file of the present invention and initiates playback of said file, the consumer will automatically initiate the playback of both the advertisement message part(s) and the music entertainment part(s).

Many different ways of implementing the system of our invention will come to the mind of the artisan, and the implementation of the system should not limit the scope of the invention. Particularly, any of the embodiments laid out before can be combined, e.g., downloading digital audio files of the invention on a computer via the Internet, but payment via a cellular phone, or purchasing a digital audio file of the invention on a local station, but gaining access to said digital audio file by receiving an e-mail having said audio file as an attachment, or burning the digital audio file of the present invention to a CD with the data transferred to the CD via the Internet, and afterwards transforming the data stored on the CD into another digital audio format such as the MP3 format, . . . All systems have in common that the digital audio file of the invention will be transferred in the end either directly or indirectly to a decoding device for playback or reproduction. In its preferred embodiments, said decoding device will be a (portable) digital audio player.

The five steps outlined above can be combined and modified in many different ways. Any combination will fall within the scope and spirit of the present invention. To further illustrate and elucidate the power of some combinations, three examples are selected and described in the following paragraphs:

### EXAMPLE (EMBODIMENT) 1

In one exemplary embodiment, the system comprises a central server that stores the digital audio files of the invention for download. The consumer can access said central server via his/her computer or a similar device by using the Internet or any functionally equivalent network. The consumer can search the central server to select the digital audio file s/he wants to acquire. For example, s/he can enter the term “Beatles” and retrieve a list of different “Beatles” songs. The consumer then places an electronic order for the intended digital audio file, e.g., “Yesterday”. As part of the ordering process, the consumer enters his/her payment information, e.g., credit card information to said central server. Said central server contacts then another server (“payment server”) to verify the validity of the information entered by the consumer and to verify the credit worthiness of the consumer. Once the consumer data have been verified, the central server acknowledges the right to download the specified digital audio file of the invention, and the consumer will be allowed to download said digital audio file. Once the digital audio file of the invention is downloaded on the consumer's computer, which in this example is a desktop PC, the consumer can playback said digital audio file using his computer hardware (e.g., a SoundBlaster sound card) and software (e.g., MusicMatch JukeBox software). Once playback is initiated, the consumer, in the present example, will first listen to an advertisement message part stating as a voice message: “The following song is brought to you by Pepsi. Enjoy! ”, directly followed by the song (music entertainment part) “Yesterday” from “The Beatles”. Assuming that the consumer also acquired the right to transfer the digital audio file to another computer or decoding device, the consumer would be able to copy said digital audio file onto a portable audio player either directly (if the audio player has an internal hard drive) or indirectly (by transferring the song to a mobile storage device such as an SD card). S/he then can take the portable audio player and thus the digital audio file of the invention with him/her and listen to the song including the advertisement message part on his/her way, while working out, while driving, or under any other imaginable circumstance.

### EXAMPLE (EMBODIMENT) 2

In another exemplary embodiment, the consumer can gain access to digital audio content by local stations. Such local stations can be located in music stores, grocery stores, bookstores, and gas stations or at any other location. Said local stations mediate access to digital audio files including digital audio files of the present invention by (a) having digital audio files locally stored (e.g., on a hard drive or other storage device) or by (b) having a network connection to a remote server with said server having stored the digital audio files, or (c) any other technically feasible means. The consumer can directly interact with said local station either via a keyboard, a touch screen, a cell phone, voice recognition or any other entering device to search and select a digital audio file, to place an order and to pay for the digital audio file. For example, s/he can enter the term “Beatles” via a keyboard or touch screen and retrieve a list of different “Beatles” songs. The consumer then places an electronic order for the intended digital audio file, e.g., “Yesterday”. Either the local station or a remote server will verify if the consumer has the right to acquire a particular digital audio file, either by verifying payment (cash; credit card; debit card; coupon; prepaid card) or by any other means technically feasible. Upon successful verification, the consumer then can receive delivery/access the digital audio file of the present invention s/he selected and ordered by any means technically feasible such as without limitation (a) wireless transmission (via Infrared (IR); Bluetooth; WiFi; 802.11a/b/g; GSM 900/1800/1900, GPRS, E-GPRS, EDGE, HSCSD, CSD, CDMA, UMTS and 3G networks; etc.) to his/her computer or decoding device including cellular phone, (b) insertion of a storage device into a slot of the local station so that the local station can copy the acquired digital audio file of the invention onto said storage device (e.g., a CD, DVD, Memory Card, Memory Stick, Secure Digital (SD) card, Multimedia (MMC) card, Compact Flash card, Smart Media card, USB Flash Disk, Microdrive), (c) the local station copying the acquired digital audio file of the invention onto a storage device (e.g. a CD, DVD, Memory Card, Memory Stick, Secure Digital (SD) card, Multimedia (MMC) card, Compact Flash card, Smart Media card, USB Flash Disk, Microdrive) that was harbored inside the local station (i.e., not inserted by the consumer) and releasing said storage device to the consumer, or (d) the local station communicates with a remote server, and the remote server either e-mails the selected digital audio file of the invention to the consumer or allows download of the selected digital audio file of the invention from the internet or notifies a shipping department to mail a hard copy of the selected digital audio file of the invention to the consumer.

Once the consumer has received delivery of the digital audio file of the invention, s/he can playback said digital audio file using a decoding device. Once playback is initiated, the consumer, in the present example, will first listen to an advertisement message part stating as a voice message: “The following song is brought to you by Pepsi. Enjoy!”, directly followed by the song (music entertainment part) “Yesterday” from “The Beatles”. Assuming that the consumer also acquired the right to transfer the digital audio file to another computer or decoding device, the consumer would be able to copy said digital audio file onto a portable audio player either directly (if the audio player has an internal hard drive) or indirectly (by transferring the song to a mobile storage device such as an SD card). S/he then can take the portable audio player and thus the digital audio file of the present invention with him/her and listen to the song including the advertisement message part on his/her way, while working out, while driving, or under any other imaginable circumstance.

### EXAMPLE (EMBODIMENT) 3

In yet another embodiment, the consumer can gain access to digital audio content including digital audio files of the present invention via his/her cellular phone. For example, the consumer can send a text or sound message specifying the digital audio file s/he wants to purchase to a central server or similar entity, and then receive the specified digital audio file of the present invention via wireless transmission on his/her cell phone or any other device s/he might specify, or via another means of delivery, e.g., emailing of the digital audio file of the present invention to an e-mail address, or gaining access to the digital audio file of the present invention via the internet. Payment in such a setting can be verified and executed via the consumer's cellular phone bill.

### EXAMPLE (EMBODIMENT) 4

In yet another exemplary embodiment, the digital audio files of the present invention are used for sales and marketing purposes in the telecommunication and music industry. Wireless and fixed network operators call the consumer's attention to the digital audio file of the present invention through push services. Especially the mobile industry is now at a point at which all the ingredients are in place for operators to become aggressive in creating and deploying new data services. Two possible scenarios for such push services are as follows: (1) The consumer will have to set up his/her profile and preferences on the Internet to receive digital audio files of the present invention on a regular basis; (2) The consumer will receive notification about the availability of a digital audio file of the present invention, if the consumer's (decoding) device, e.g. a cellular phone, a personal digital assistant, etc., is ready-to-receive push services. In the latter, the consumer receives for example notification by SMS or any other push-enabled technology that new digital audio files of the present invention are available for download. In the subscriber based model the consumer will receive digital audio files of the present invention on a regular basis, for example at night when network traffic is small.

Similarly, a consumer might subscribe to a service that pushes once a week 10 digital audio files of the present invention to his/her decoding device (cellular phone) with each digital audio file comprising one Top 10 hit of the U.S. billboard charts as music entertainment part. Alternatively, a digital audio file of the present invention might be pushed to the consumer's decoding device (cellular phone) comprising a part (e.g., the first 30 seconds) of a single as music entertainment part together with an advertisement message part, where said advertisement message part preferentially states a web page where the consumer might download a digital audio file comprising the complete single as music entertainment part with or without an advertisement message part.

### EXAMPLE (EMBODIMENT) 5

In yet another exemplary embodiment, the digital audio file of the present invention contains a specific message depending on the artist's record label. Examples of potential advertisement message parts are “It's a Sony song”, “BMG's best music” or any kind of message that is suitable to communicate the identity of the record label. Additionally, record labels could offer their own network based download portal. Thus consumers who listen to a digital audio file of the present invention instantly know the record label and consequently look for the song on the download portal of the record label even if they do not know the title or the artist of the song. This will not only push sales of well-known artists but also help sales of unknown artists signed by the same record label.

### EXAMPLE (EMBODIMENT) 6

Yet another embodiment is a subscriber based service to distribute digital audio files of the present invention. The consumer subscribes to an Internet or another networkbased service. However, the digital audio files are newly arranged each time a consumer logs on to the service and listens to music, i.e. the server contains a certain number of advertisement message parts as well as music entertainment parts that are randomly or subscriber-specifically assembled. It is also possible that the digital audio files of the present invention are pre-fabricated and the same for all users. The digital audio file is then streamed but not downloaded to the consumer's computer or device.

In summary, the method and system of the present invention provide a new business model for generating additional revenues from delivering and/or selling digital audio files by incorporating at least one advertisement message part.

1. A method and system for selling and/or distributing a digital audio file wherein said digital audio file comprises
(a) an advertisement message part in a digital audio format, and
(b) a music entertainment part in a digital audio format.

2. The method and system of claim 1 wherein said advertisement message part
(a) directly precedes the music entertainment part, and/or
(b) directly follows the music entertainment part, and/or
(c) is located within (interrupts) the music entertainment part, and/or
(d) is overlaid (superimposed) on the music entertainment part, and/or
(e) overlaps with the music entertainment part.

3. The method and system of claims 1 and 2 wherein the advertisement message part and the music entertainment part are integrated into the digital audio file so that both parts are reproduced or played together on a decoding or playback device once a decoding or playback is initialized by a user, hardware, or software.

4. The method and system of claims 1 and 2 wherein said digital audio file refers to a file format selected from at least one of the following file formats: MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, MIDI, WAV, or any other digital format or electronic music distribution (EMD) system.

5. The method and system of claims 1 and 2 wherein said advertisement message part is in a digital audio format comprising MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, MIDI, WAV, or any other digital format or electronic music distribution (EMD) system.

6. The method and system of claims 1 and 2 wherein said music entertainment part is in a digital audio format comprising MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, MIDI, WAV, or any other digital format or electronic music distribution (EMD) system.

7. The method and system of claims 1 to 6 wherein said advertisement message part and said music entertainment part are in the same digital audio format.

8. The method and system of claims 1 to 6 wherein said advertisement message part and said music entertainment part are in different digital audio formats.

9. The method and system of claims 1 to 8 wherein the digital audio file of the present invention is in an uncompressed digital audio format.

10. The method and system of claims 1 to 8 wherein the digital audio file of the present invention is in a compressed digital audio format.

11. The method and system of claims 1 to 3 wherein said digital audio file comprising an advertisement message part and a music entertainment part is sold at a lower price than a digital audio file comprising said same music entertainment part, but no advertisement message part.

12. The method and system of claims 1 to 3 wherein playback of said advertisement message part does not take more than preferentially 15%, more preferentially 10% and most preferentially 5% of the time it takes to playback said music entertainment part.

13. The method and system of claims 1 to 3 wherein said advertisement message part and said music entertainment part are sold, distributed, acquired, accessed, downloaded, delivered, transferred, transmitted and/or received as parts of the same digital audio file.

14. The method and system of claims 1, 2, 3 and 13 wherein said digital audio file is sold, distributed, acquired, accessed, downloaded, delivered, transferred, transmitted and/or received via
(a) the Internet (including downloading; e-mail; wired; wireless via WiFi, 802.11a/b/g, 802.16); and/or
(b) wireless phone networks based on transmission standards like GSM 900/1800/1900, GPRS, E-GPRS, EDGE, HSCSD, CSD, CDMA, UMTS and 3G networks; and/or
(c) wireless transmission (Bluetooth 1.0; Bluetooth 2.0; Infrared; WiFi; 802.11a/b/g; 802.16); and/or
(d) local (computer) stations that might be located in or outside of stores (e.g., music retail stores); and/or
(e) storage devices including CDs, DVDs, Memory Cards, Memory Sticks, Secure Digital (SD) cards, Multimedia (MMC) cards, Compact Flash cards, Smart Media cards, USB Flash Disks, Microdrives; and/or
(f) radio, terrestric, cable or satellite transmission.

15. The method and system of claims 1 and 2 wherein said advertisement message part advertises, mentions, and/or refers to
(a) physical products including food, drugs, beverages, cars, tobacco, cosmetics; and/or
(b) services such as banking, financial services, travel, leisure activities, phone service, wireless service, cable service; and/or
(c) companies, brands, institutions, corporations, (legal) entities; and/or
(d) entertainment content such as movies, television content, music; and/or
(e) events such as sporting events, cultural events; and/or
(f) persons, artists, groups, or individuals; and/or
(g) a general message (such as referral to a web site where a specific product can be acquired); and/or
(h) advice; and/or
any combination within and/or between the different groups.

16. The method and system of claims 1 and 2 wherein said advertisement message part comprises
(a) music; and/or
(b) sound; and/or
(c) noise; and/or
(d) spoken words; and/or
(e) a jingle or music branding; and/or
(f) voice branding; and/or
any combination within and/or between the different groups.

17. The method and system of claims 1, 2 and 6 wherein said music entertainment part is a digital audio format of a single or a digital audio format of a part of a single that is or was listed on the Billboard Hot 100 single charts or Top 40 tracks.

18. The method and system of claims 1, 2 and 6 wherein said music entertainment part is a digital audio format of at least one past, present or future single independent of the way it is published.

19. The method and system of claims 1, 2 and 3 wherein the content and/or position of said advertisement message part can change from playback to playback of the digital audio file of the present invention.

20. The method and system of claims 1 and 2 wherein said digital audio file is played-back or reproduced on a computer, decoding device, (portable) MP3 player, (portable) digital music player, (portable) digital audio player, cellular phone, smart phone.

21. The method and system of claims 1, 2, 3, 11, 13, 14, 15 and 16 wherein the consumer acquires the right to play a specific digital audio file of the present invention for an unlimited number of times by paying a specific price at one point in time.

22. The method and system of claims 1, 2, 3, 11, 13, 14, 15 and 16 wherein the consumer acquires the right to play one or more digital audio files of the present invention for an unlimited number of times by paying a subscription fee.

23. The method and system of claims 1, 2, 3, 11, 13, 14, 15 and 16 wherein the consumer pays a specific price each time the consumer plays a digital audio file of the present invention.

24. A method and system for selling and/or distributing a digital audio file wherein said digital audio file comprises
(a) at least one advertisement message part in a digital audio format, and
(b) at least one music entertainment part in a digital audio format.

25. The method and system of claim 24 wherein said advertisement message part(s)
(a) directly precede(s) the music entertainment part(s), and/or
(b) directly follow(s) the music entertainment part(s), and/or
(c) is (are) located within (interrupt(s)) the music entertainment part(s), and/or
(d) is (are) overlaid (superimposed) on the music entertainment part(s), and/or
(e) overlap(s) with the music entertainment part(s).

26. The method and system of claims 24 and 25 wherein the advertisement message part(s) and the music entertainment part(s) are integrated into the digital audio file so that all parts are reproduced or played together on a decoding or playback device once a decoding or playback is initialized by a user, hardware, or software.

27. The method and system of claims 24 and 25 wherein said digital audio file refers to a file format selected from at least one of the following file formats: MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, MIDI, WAV, or any other digital format or electronic music distribution (EMD) system.

28. The method and system of claims 24 and 25 wherein said advertisement message part(s) is (are) in a digital audio format comprising MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, MIDI, WAV, or any other digital format or electronic music distribution (EMD) system.

29. The method and system of claims 24 and 25 wherein said music entertainment part(s) is (are) in a digital audio format comprising MPEG-2.AAC (Advanced Audio Coding), ATRAC3 (Adaptive Transform Acoustic Coding 3), MP3 (MPEG-1. Audio Layer 3), mp3PRO, MS audio (WMA: Windows Media Audio), TwinVQ (Transform-Domain Weighted Interleave Vector Quantization), Q design, RealAudio, AMR-NB, MP4, MIDI, WAV, or any other digital format or electronic music distribution (EMD) system.

30. The method and system of claims 24 to 29 wherein said advertisement message part(s) and/or said music entertainment part(s) are in the same digital audio format.

31. The method and system of claims 24 to 29 wherein said advertisement message part(s) and/or said music entertainment part(s) are in different digital audio formats.

32. The method and system of claims 24 to 31 wherein the digital audio file of the present invention is in an uncompressed digital audio format.

33. The method and system of claims 24 to 31 wherein the digital audio file of the present invention is in a compressed digital audio format.

34. The method and system of claims 24 to 26 wherein said digital audio file comprising at least one advertisement message part and at least music entertainment part is sold at a lower price than a digital audio file comprising said same music entertainment part(s), but no advertisement message part(s).

35. The method and system of claims 24 to 26 wherein playback of said advertisement message part(s) does not take more than preferentially 15%, more preferentially 10% and most preferentially 5% of the time it takes to playback said music entertainment part(s).

36. The method and system of claims 24 to 26 wherein said advertisement message part(s) and said music entertainment part(s) are sold, distributed, acquired, accessed, downloaded, delivered, transferred, transmitted and/or received as parts of the same digital audio file.

37. The method and system of claims 24, 25, 26 and 36 wherein said digital audio file is sold, distributed, acquired, accessed, downloaded, delivered, transferred, transmitted and/or received via
(a) the Internet (including downloading; e-mail; wired; wireless via WiFi, 802.11a/b/g); and/or
(b) wireless phone networks based on transmission standards like GSM 900/1800/1900, GPRS, E-GPRS, EDGE, HSCSD, CSD, CDMA, UMTS and 3G networks; and/or
(c) wireless transmission (Bluetooth 1.0; Bluetooth 2.0; Infrared; WiFi; 802.11a/b/g; 802.16); and/or
(d) local (computer) stations that might be located in or outside of stores (e.g., music retail stores); and/or
(e) storage devices including CDs, DVDs, Memory Cards, Memory Sticks, Secure Digital (SD) cards, Multimedia (MMC) cards, Compact Flash cards, Smart Media cards, USB Flash Disks, Microdrives; and/or
(f) radio, terrestric, cable or satellite transmission.

38. The method and system of claims 24 and 25 wherein said advertisement message part(s) advertise(s), mention(s), and/or refer(s) to
(a) physical products including food, drugs, beverages, cars, tobacco, cosmetics; and/or
(b) services such as banking, financial services, travel, leisure activities, phone service, wireless service, cable service; and/or
(c) companies, brands, institutions, corporations, (legal) entities; and/or
(d)entertainment content such as movies, television content, music; and/or
(e) events such as sporting events, cultural events; and/or
(f) persons, artists, groups, or individuals; and/or
(g) a general message (such as referral to a web site where a specific product can be acquired); and/or
(h) advice; and/or
any combination within and/or between the different groups.

39. The method and system of claims 24 and 25 wherein said advertisement message part(s) comprise(s)
(a) music; and/or
(b) sound; and/or
(c) noise; and/or
(d) spoken words; and/or
(e) a jingle or music branding; and/or
(f) voice branding; and/or
any combination within and/or between the different groups.

40. The method and system of claims 24, 25 and 29 wherein at least one music entertainment part is a digital audio format of a single or a digital audio format of a part of a single that is or was listed on the Billboard Hot 100 single charts or Top 40 tracks.

41. The method and system of claims 24, 25 and 29 wherein at least one music entertainment part is a digital audio format of at least one past, present or future single independent of the way it is published.

42. The method and system of claims 24, 25 and 26 wherein the content and/or position of said advertisement message part(s) can change from playback to playback of the digital audio file of the present invention.

43. The method and system of claims 24 and 25 wherein said digital audio file is played-back or reproduced on a computer, decoding device, (portable) MP3 player, (portable) digital music player, (portable) digital audio player, cellular phone, smart phone.

44. The method and system of claims 24, 25, 26, 34, 36, 37, 38 and 39 wherein the consumer acquires the right to play a specific digital audio file of the present invention for an unlimited number of times by paying a specific price at one point in time.

45. The method and system of claims 24, 25, 26, 34, 36, 37, 38 and 39 wherein the consumer acquires the right to play one or more digital audio files of the present invention for an unlimited number of times by paying a subscription fee.

46. The method and system of claims 24, 25, 26, 34, 36, 37, 38 and 39 wherein the consumer pays a specific price each time the consumer plays a digital audio file of the present invention.
